(19) United States
(12) Patent Application Publication
(10) Pub. No.: US 2003/0235170 A1
(43) Pub. Date: Dec. 25, 2003

(54) Method, apparatus, and system for distributed access points for wireless local area network (LAN)

(76) Inventor: Solomon B. Trainin, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/177,295

(22) Filed: Jun. 21, 2002

(51) Int. Cl. H04Q 7/24

(52) U.S. Cl. 370/338; 370/349

(57) ABSTRACT

According to one embodiment of the invention, an apparatus is provided that includes an access point repeater (APR) coupled to a wired network. The APR transmits information to and receives information from one or more associated stations according to a first wireless processing protocol. The APR performs the media access functions of the first wireless processing protocol. The apparatus further includes an access point server (APS) coupled to the APR via the wired network to transmit information to and receive information from the APR. The APS performs specific point control functions of the first wireless processing protocol.

### FIELD

An embodiment of the invention relates to the field of data communications, and more specifically, relates to a method, apparatus, and system for distributed access points for wireless local area network (LAN).

### BACKGROUND

In the past few years, communication systems have continued to advance rapidly in light of several technological advances and improvements with respect to communication networks and protocols, in particular wireless communication networks. Wireless local area networks have become increasingly used to facilitate effective and efficient information communication in various environments and improve user mobility and flexibility. A wireless local area network (LAN) can be implemented to extend the connectivity of a wired local area network or as an alternative of a wired local area network.

FIG. 1 illustrates an embodiment of a typical wireless network system 100. The wireless network system 100 includes a link 110 based on a physical medium, which is part of a wired network 115 (e.g., a wired local area network such as an Ethernet LAN). The wired network 115 includes network or system resources 120 that can be accessed and used by users of the network system 100. For example, the system or network resources 120 may include network servers, file servers, system databases, application programs, etc. As shown in FIG. 1, the network system 100 further includes multiple access points (APs) 130A-130C that communicate via a wireless link with their associated mobile units (MUs) 140A-140E. The mobile units are also referred to as mobile stations or simply stations herein. Users of the mobile units 140A-140E can access and use the system resources 120 via the access points 130A-130C. The access points 130A-130C are used as bridges between the wired network 115 and a wireless network comprised of mobile units 140A-140E. In other words, the access points 130A-130C provide connectivity between the wired network 115 and the mobile units 140A-140E and also between the mobile units themselves. Typically, the mobile units 140A-140E communicate with the access points 130A-130C using a standardized protocol (e.g., the Institute of Electrical and Electronic Engineers (IEEE) 802.11 wireless communication standard, published Nov. 16, 1998).

Generally, an access point is used to for various purposes or functions including: (1) providing connection between the mobile units or stations and the wireless network; (2) performing the point control functions for the associated mobile units, as defined by a standardized protocol such as the IEEE 802.11 standard; and (3) providing the connectivity between the wireless network and the wired network (e.g., an Ethernet network). The second function performed by an access point requires computation and memory resources. However, the first function performed by an access point can be considered as the function of a radio repeater. Each access point in a typical wireless network requires to be equipped and configured to perform all of those functions mentioned above. Such a configuration may result in under-utilization of the resources and capacity of some access points and over-utilization of other access points in the wireless network. For example, for a given period of time, it is assumed that the access point 130A is required to perform the point control functions for all of its associated mobile units while another access point such as 130B is only performing the connectivity function for its associated mobile units. In this example, it can be seen that access point 130A is over-utilized and access point 130B is under-utilized with respect to their computation and memory resources required to perform their corresponding functions. As a result, the conventional configuration of access points in a wireless network can be inefficient with respect to cost, flexibility, and scalability of resources.

### BRIEF DESCRIPTION OF THE DRAWINGS

The invention may best be understood by referring to the following description and accompanying drawings that are used to illustrate embodiments of the invention. In the drawings:

FIG. 1 shows a block diagram of a wireless network system;

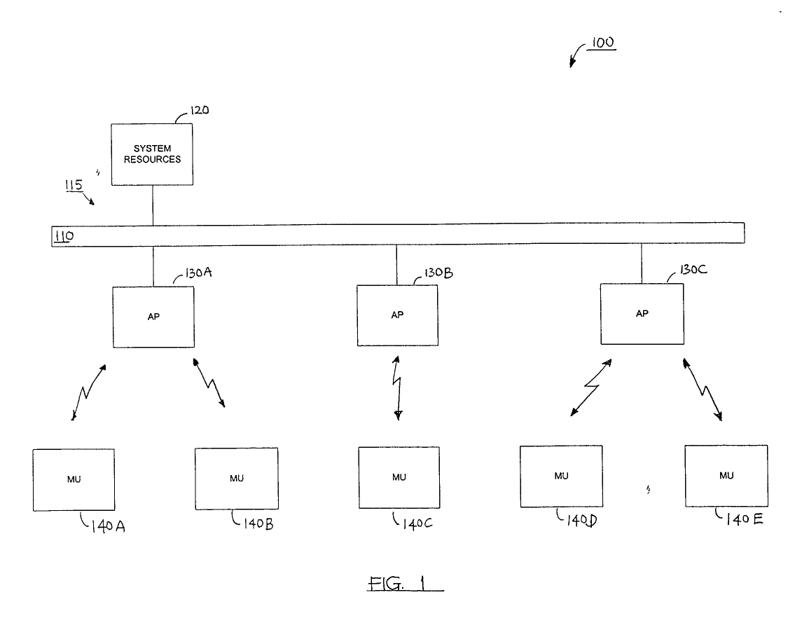

FIG. 2 illustrates a block diagram of a wireless network configuration according to one embodiment of the invention;

FIG. 3 shows a block diagram of an access point repeater (APR) according to one embodiment of the invention;

FIG. 4 shows a block diagram of an access point server (APS) according to one embodiment of the invention;

FIG. 5 shows a flow diagram of a process according to one embodiment of the invention; and

FIG. 6 illustrates a flow diagram of a method according to one embodiment of the invention.

### DETAILED DESCRIPTION

In the following detailed description numerous specific details are set forth. However, it is understood that embodiments of the invention may be practiced without these specific details.

As mentioned above, an access point in a wireless network system is used to for various purposes or functions including: (1) providing connection between the mobile units or stations and the wireless network; (2) performing the point control functions for the associated mobile units, as defined by a standardized protocol such as the IEEE 802.11 standard; and (3) providing the connectivity between the wireless network and the wired network (e.g., an Ethernet network). The second function performed by an access point requires computation and memory resources. However, the first function performed by an access point can be considered as the function of a radio repeater.

In one embodiment of the invention, a distributed access point configuration is implemented for a wireless local area network system. Instead of having each access point configured and equipped to perform both the media access functions and the specific point control functions according to a wireless communication protocol or standard such as the IEEE 802.11 standard, an access point according to one embodiment of the invention is comprised of two parts or two components. One component is called an access point repeater (APR) and the other component is called an access point server (APS). In one embodiment, one APS can support multiple access point repeaters (APRs).

In one embodiment of the invention, the functions that are performed by a conventional or traditional access point in a wireless network system are split between the APR and the APS. In one embodiment, the APR can be used to perform the media access functions of a standardized access control protocol such as the medium access control (MAC) protocol as specified in the IEEE 802.11 standard. The APS, in one embodiment, can be used to perform the specific point control functions that are relatively not real-time functions. In one embodiment, the APR and the APS are connected via a wired network (e.g., an Ethernet wired LAN) to communicate with each other.

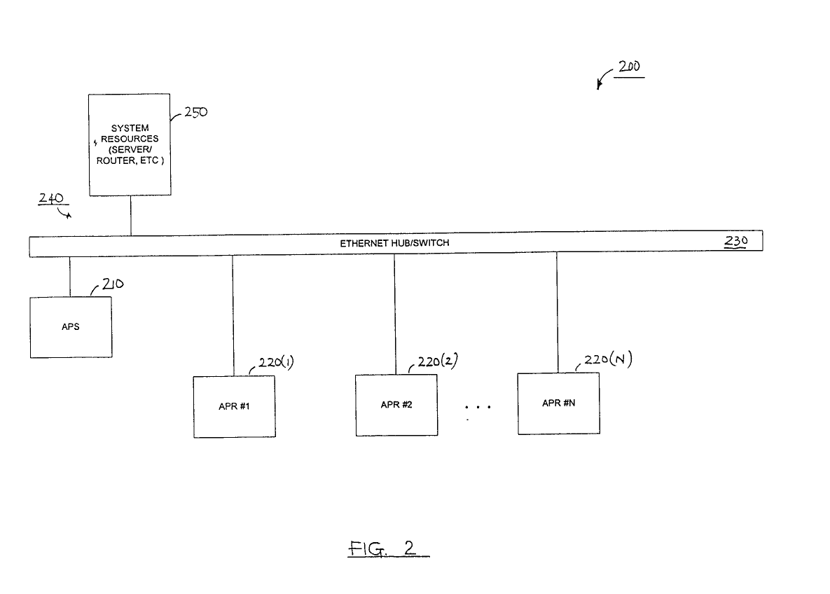

FIG. 2 illustrates a block diagram of a wireless network configuration 200 according to one embodiment of the invention. As shown in FIG. 2, the wireless network configuration 200 includes an access point server (APS) 210, one or more access point repeaters (APRs) 220(1)- 220(N). The APS 210 and the APRs 220 are connected and communicate with each other via a link 230, which is part of a wired network 240. In one embodiment, the wired network 240 is an Ethernet wired local area network (LAN) and the link 230 can be an Ethernet hub or switch. The network configuration 200 further includes system resources 250 (e.g., server/router) that are coupled to network link 230.

In one embodiment, each APR 220 can be associated with one or more mobile units (not shown). Mobile units are also referred to as mobile stations or simply stations herein. A “mobile unit” (MU) can be any electronic device that includes logic for processing information (e.g., a processor, microcontroller, state machine, etc.) and a wireless transceiver for receiving information from and transmitting information to another electronic device (e.g., an APR or another mobile unit, etc.). Mobile units may include computers (e.g., desktop computers, laptop computers, hand-held computers such as a personal digital assistant “PDA”, etc.), communications equipments (e.g., pagers, telephones, facsimile machines, etc.), television set-top boxes, PC cards, PCI adapters, bar-code scanners, etc. In one embodiment, an APS such as the APS 210 can be configured to support multiple APRs such as APR 220(1)-220(N).

In one embodiment, the APR 220 is used to perform the media access portion of the MAC protocol that needs real-time performance and wireless physical layer (PHY) functionality. As shown in FIG. 2, each APR 220 is connected with the APS 210 through the Ethernet link 230. In one embodiment, the APS 210 is a software application that can run on any Ethernet-aware platform (e.g., server, router, switch, etc.). The APS 210 performs the specific point control functions of a wireless communication protocol such as the IEEE 802.11 standard. The specific point control functions are relatively not real-time functions. For example, in one embodiment, the APS 210 is responsible for getting and storing frames that cannot be immediately delivered or released due to the power state of the receiving stations. In one embodiment, the APS 210 can also perform the wired equivalent privacy (WEP) and other non-MAC layer security/authentication algorithms or functions such as security key distribution. In one embodiment, the APR 220 includes 802.11 physical layer (PHY), all or part of the 802.11 MAC component, Ethernet MAC and PHY, MAC address filter, one or more buffers (e.g., FIFO buffers) and corresponding buffer control logic. In one embodiment, one FIFO buffer is used for wireless to wired network (e.g., wireless to Ethernet) information transfer. One or more FIFO buffers are used for wired network to wireless (e.g., Ethernet to wireless) information transfer to allow for flexibility in case of priority and PCF (point coordination function) support. For example, one FIFO buffer can be used to collect frames sent by DCF (distributed coordination function) and another FIFO buffer can be used to collect frames sent by PCF. In one embodiment, multiple FIFO buffers may be used to support priority queues and fragmentation also.

According to one embodiment of the invention, MAC multi-addressing mechanism is utilized as follows. Each APR 220 is a multi-addressable entity or device on the wired network (e.g., Ethernet LAN). Each APR 220 is associated in the APS 210 with every MAC address of stations supported by the respective APR 220. The APS 210 is also a multi-addressable entity or device on the wired network (e.g., Ethernet LAN). The APS 210 obtains from the Ethernet the basic service set identifier (BSSID) addresses of the APRs that are connected to the APS 210. In this configuration, no look up is needed to process frames transferred between stations, APR, and APS.

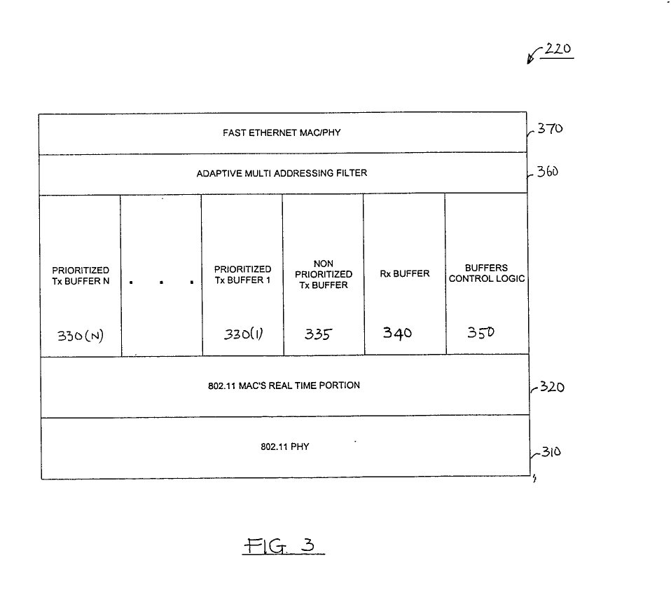

FIG. 3 shows a block diagram of an access point repeater (APR) 220 according to one embodiment of the invention. As shown in FIG. 3, in one embodiment, APR 220 may include IEEE 802.11 physical layer (PHY) 310, IEEE 802.11 MAC Real Time portion 320, one or more prioritized transmit buffers 330, one or more non-prioritized transmit buffers 335, one or more receive buffers 340, buffers control logic 350. The APR 220 further includes adaptive multi-addressing filter 360 and Ethernet MAC/PHY layer 370 These various components are used by the APR 220 to perform its corresponding media access functions of the MAC protocol that need real-time performance and wireless PHY functionality.

In one embodiment, APR 220 is a multi-addressable entity on the wired network (e.g., the Ethernet LAN). The APR 220 is addressable by MAC address of any station associated with APR 220. The APR 220 includes a table of addresses which is updated each time a station is associated with or disassociated from the APR 220. In one embodiment, the APR 220 receives all frames directed to it via the wireless medium (e.g., air) according to a wireless communication standard such as the IEEE 802.11 standard. Control frames received by the APR 220 are processed by the APR 220. Management frames are directed by the APR 220 to the APS 210. Data frames can be redirected by the APR 220 to the appropriate station provided that certain criteria are satisfied. For example, the APR 220 can redirect data frames to a station when the respective station is in the same basic service set (BSS), in the proper power state to receive data, and that the APR 220 is able to properly perform the required security functions, if necessary, with respect to the data frames to be sent (e.g., decrypt and/or encrypt).

In one embodiment, the APR 220 will redirect a data frame to the APS 210 if the data frame should be stored or needs decryption/encryption processing that the APR 220 is not able to provide. The APR 220 redirects the received data frame to the APS 210 by enveloping the data frame in an Ethernet frame and using the corresponding BSSID as the destination address.

In one embodiment, the APR 220 gets Ethernet frames from APS 210 to be sent to a corresponding station via the wireless medium (e.g., air). These frames contain valid 802.11 frames under Ethernet envelope. Destination address of these frames is the address of the corresponding station. There can be various kinds of frames sent from the APS 210 to the APR 220. They may include frames for immediate transmission and frames that should be sent in a particular manner (e.g., PCF). In this case, the APR 220 can recognize and store such frames for later use.

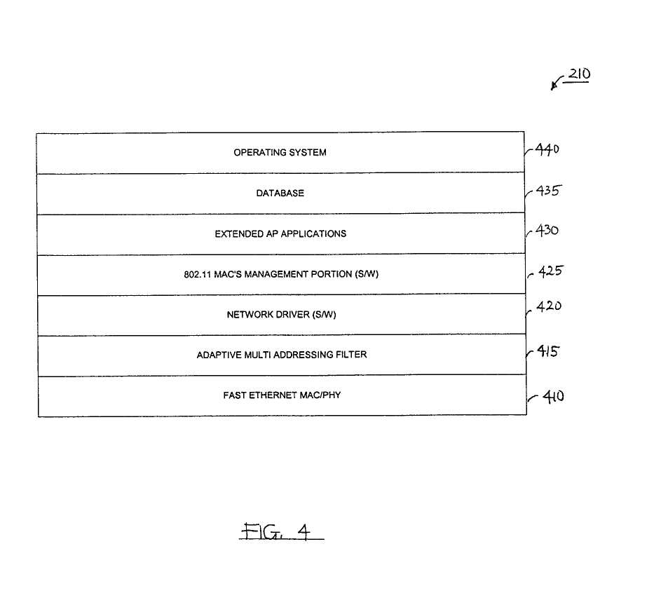

FIG. 4 shows a block diagram of an access point server (APS) (e.g., APS 210) according to one embodiment of the invention. As shown in FIG. 4, APS 210 may include an Ethernet MAC/PHY layer 410, an adaptive multi-addressing filter 415, a network driver 420, IEEE 802.11 MAC management portion 425, and one or more extended access point (AP) applications 430. The APS 210 may further include a database 435 for storing information and an operating system 440 for controlling the operations of the various components included in the APS 210.

In one embodiment, the APS 210 is configured as a multi-addressable entity on the wired network (e.g., Ethernet LAN). The APS 210 can be addressable by the corresponding BSSID of any APR supported by APS 210. In one embodiment, the APS 210 receives redirected frames from the APR 220 which are enveloped in Ethernet format. The BSSID of the respective APR 220 is used as the destination address. In one embodiment, APS 210 gets all management frames redirected to APS 210 by APR 220. The APS 210 may also get some control frames and data frames. The APS 210 is responsible for performing management functions of the wireless communication protocol (e.g., IEEE 802.11).

In one embodiment, the APS 210 is configured to store data frames that cannot be immediately sent to stations because the stations are in power down state. The APS 210 also forwards data frames between basic service sets. In one embodiment, the APS 210 creates, stores, and distributes security keys between stations. The APS 210 allows usage of individual key for any station.

In one embodiment, the APS 210 sends IEEE 802.11 frames to the APR 220 for transmission over the wireless medium to the stations. The APS 210 envelops these frames in Ethernet format. The destination address of these frames is the address of the station. The APS 210 could allow roaming between APRs by substitution of the BSSID in the registry of stations.

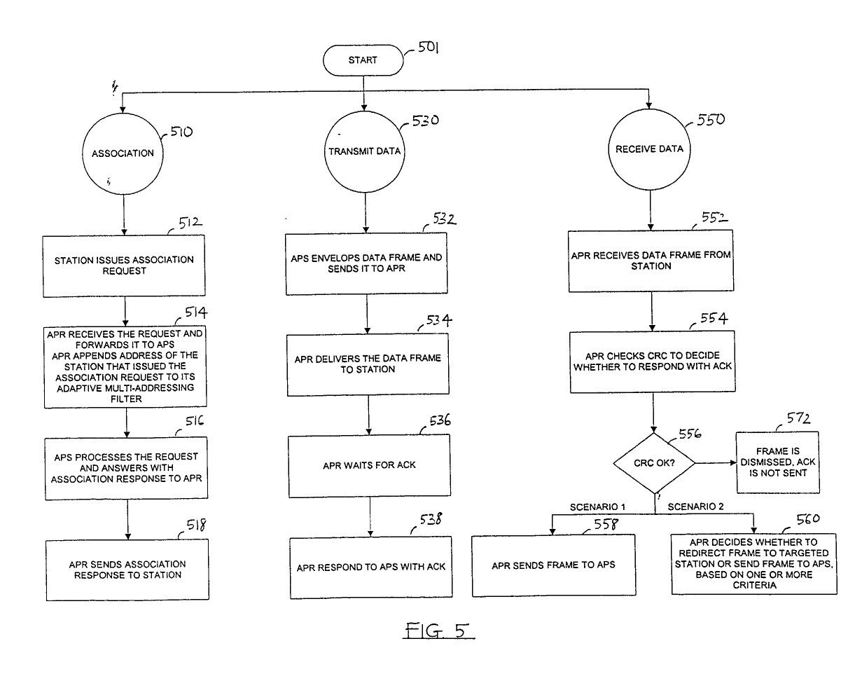

FIG. 5 shows a flow diagram of a process 500 according to one embodiment of the invention. As shown in FIG. 5, the process 500 includes the association phase or sub-process 510, the transmit data phase or sub-process 530, and the receive data or sub-process 550. At block 512, a station issues an association request with a BSSID. At block 514, an APR with the corresponding BSSID receives the respective association request and forwards the association request to an APS. In one embodiment, the APR appends the address of this station to its adaptive multi-addressing filter. At block 516, the APS processes the association request and answers with an association response. The association response is then sent from the APS to the APR through a wired network (e.g., the Ethernet LAN). The association response frame is enveloped in an Ethernet format using the station address as the destination address. If the response is unsuccessful, the last added MAC address is removed from the APR's adaptive multi-addressing filter. At block 518, the APR sends the association response to the station via the wireless medium (e.g., air).

Referring again to FIG. 5, at block 532, to transmit a data frame from the APS to an APR, the APS envelopes the frame to be transmitted in Ethernet format using the station address as the destination address and sends the data frame to the APR via the wired network (e.g., the Ethernet LAN). The APR that receives the data frame is responsible for delivering this data frame to the corresponding station so that the APS can free the buffer of this data frame (at block 534). At block 536, the APR transmits the data frame to the respective station and waits for an acknowledgement signal (ACK) from the respective station. At block 538, the APR responds to the APS with the ACK signal so that the APS can determine whether the APR frees its buffer for the next frame.

Continuing with the present discussion, at block 552, a station (also called a first station) transmits data to another station (called a second station). The APR recognizes the BSSID of the frame and receives the frame from the first station. At block 554, the APR checks the CRC of the frame received to decide whether to respond with ACK. At decision block 556, if the CRC fails (CRC not OK), the frame is dismissed and ACK is not sent by the APR (at block 572). If the CRC is successful (CRC OK), there can be different scenarios to process the frame. For example, in one embodiment, in one scenario, the APR can be configured to send any data frame received from a station to the APS (scenario 1, block 558). In this case, the APR forwards the data frame to the APS which is enveloped with an Ethernet header and using the BSSID as the destination address. The APS then decides how to process the data frame (e.g., how to decrypt the data frame, to store it or to forward for transmission to the targeted station).

Alternatively, in another embodiment (scenario 2), the APR may be configured to decide whether to redirect the received data frame to the targeted station or to send the data frame to the APS, based on various factors or criteria (at block 560). For example, the various factors or criteria used by the APR to determine whether to redirect the data frame to the targeted station or send the data frame to the APS may be based the APR's capabilities to perform certain required functions to process and transmit the data frame, the power state of the targeted station, whether the targeted station is in the same BSS as the transmitting station, etc. For example, if each station uses its own key for encryption and the APR does not have enough space to store keys for all stations then the APR needs to forward the data frame to the APS. As another example, if the targeted station is in power down mode then the APR needs to send the data frame to the APS to be stored for transmission to the targeted station later on.

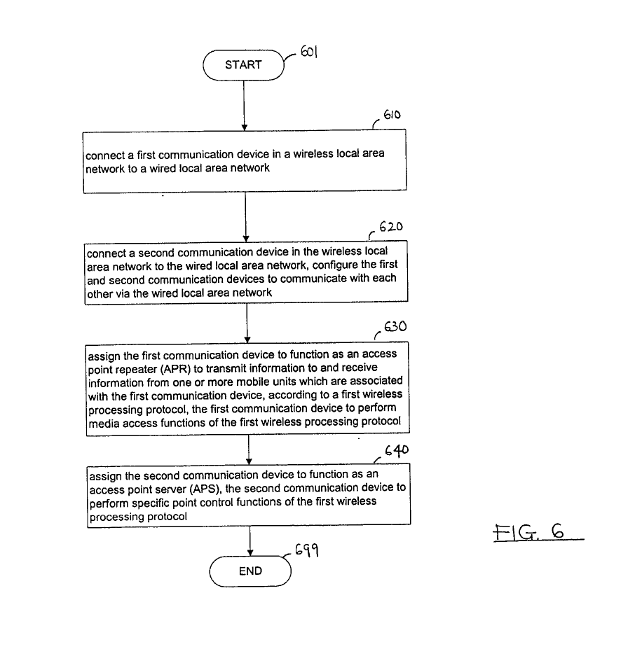

FIG. 6 illustrates a flow diagram of a method 600 according to one embodiment of the invention. At block 610, a first communication device in a wireless local area network is connected to a wired local area network. At block 620, a second communication device in the wireless local area network is connected to the wired local area network. The first and second communication devices communicate with each other via the wired local area network. At block 630, the first communication device is assigned and configured to function as an access point repeater (APR) to transmit information to and receive information from one or more mobile units (stations) that are associated with the first communication device, according to a first wireless processing protocol (e.g., IEEE 802.11 standard). The first communication device is configured to perform the media access functions of the first wireless processing protocol (e.g., the media access portion of IEEE 802.11 MAC protocol). At block 640, the second communication device is assigned and configured to function as an access point server (APS). The second communication device is configured to perform specific point control functions of the first wireless processing protocol that are relatively not real-time functions.

While the invention has been described in terms of several embodiments, those of ordinary skill in the art will recognize that the invention is not limited to the embodiments described herein. It is evident that numerous alternatives, modifications, variations and uses will be apparent to those of ordinary skill in the art in light of the foregoing description.

What is claimed is:

1. An apparatus comprising:
an access point repeater (APR) coupled to a wired network, the APR to transmit information to and receive information from one or more associated stations according to a first wireless processing protocol, the APR to perform media access functions of the first wireless processing protocol; and
an access point server (APS) coupled to the APR via the wired network to transmit information to and receive information from the APR, the APS to perform specific point control functions of the first wireless processing protocol.

2. The apparatus of claim 1 wherein the APR is a multi-addressable entity on the wired network and is addressable by corresponding media access control (MAC) addresses of stations associated with the APR.

3. The apparatus of claim 2 wherein the APR includes a table of MAC addresses of associated stations, the table being updated each time a respective station is associated with or disassociated from the APR.

4. The apparatus claim 1 wherein the APS is a multi-addressable entity on the wired network and is addressable by corresponding basic service set identifiers (BSS_ID) of access point repeaters that are supported by the APS.

5. The apparatus of claim 1 wherein the wired network is an Ethernet network and wherein the first wireless processing protocol conforms with the Institute of Electrical and Electronics Engineers (IEEE) 802.11 wireless standard.

6. The apparatus of claim 1 wherein, in response to an association request issued by a first station, the APR forwards the respective association request to the APS which processes the respective association request and sends a corresponding association response to the APR, and wherein the APR sends the corresponding association response to the first station.

7. The apparatus of claim 6 wherein, to transmit a data frame from the APR to the first station, the APS sends the data frame enveloped in Ethernet format with the address of the first station used as a destination address (DA) to the APR via the wired network, and wherein the APR sends the data frame to the first station.

8. The apparatus of claim 7 wherein, upon receiving a data frame from the first station to be transmitted to a second station, the APR sends the data frame to the APS for transmission to the second station.

9. The apparatus of claim 7 wherein, upon receiving a data frame from the first station to be transmitted to a second station, the APR redirects the data frame to the second station if one or more criteria are met, the one or more criteria including a first criterion indicating whether the second station is in the same basic service set (BSS) as the first station, a second criterion indicating whether the second station is in a proper power state to receive data frames, and a third criterion indicating whether the APR is capable of performing one or more data security functions required to process the data frame before transmitting the data frame to the second station.

10. A system comprising:
a wired local area network;
a wireless local area network including one or more mobile units to transmit and receive information via a wireless medium;
a first access point coupled to the wired local area network, the first access point to function as an access point repeater (APR) to transmit information to and receive information from one or more mobile units which are associated with the first access point, according to a first wireless processing protocol, the first access point to perform media access functions of the first wireless processing protocol; and
a second access point coupled to communicate with the first access point via the wired local area network, the second access point to function as an access point server (APS), the second access point to perform specific point control functions of the first wireless processing protocol.

11. The system of claim 10 wherein the first access point is a multi-addressable entity on the wired local area network and is addressable by corresponding media access control (MAC) addresses of mobile units associated with the first access point.

12. The system of claim 11 wherein the second access point is a multi-addressable entity on the wired local area network and is addressable by corresponding basic service set identifiers (BSS_ID) of access point repeaters (APR) which are supported by the second access point.

13. The system of claim 12 wherein, in response to an association request issued by a first mobile unit, the first access point forwards the respective association request to the second access point which processes the respective association request and sends a corresponding association response to the first access point, and wherein the first access point sends the corresponding association response to the first mobile station.

14. The system of claim 13 wherein, to transmit a data frame from the second access point to the first mobile unit, the second access point sends the data frame enveloped in Ethernet format with the address of the first mobile unit used as a destination address (DA) to the first access point via the wired local area network, and wherein the first access point sends the data frame to the first mobile unit.

15. The system of claim 14 wherein, upon receiving a data frame from the first mobile unit to be transmitted to a second mobile unit, the first access point sends the data frame to the second access point for transmission to the second mobile unit.

16. The system of claim 14 wherein, upon receiving a data frame from the first mobile unit to be transmitted to a second mobile unit, the first access point redirects the data frame to the second mobile station if one or more criteria are met, the one or more criteria includes a first criterion indicating whether the second mobile station is in the same basic service set (BSS) as the first mobile station, a second criterion indicating whether the second mobile station is in a proper power state to receive data frames, and a third criterion indicating whether the first access point is capable of performing one or more data security functions required to process the data frame.

17. A method comprising:
connecting a first communication device in a wireless local area network to a wired local area network;
connecting a second communication device in the wireless local area network to the wired local area network, the first and second communication devices to communicate with each other via the wired local area network;
assigning the first communication device to function as an access point repeater (APR) to transmit information to and receive information from one or more mobile units which are associated with the first communication device, according to a first wireless processing protocol, the first communication device to perform media access functions of the first wireless processing protocol; and
assigning the second communication device to function as an access point server (APS), the second communication device to perform specific point control functions of the first wireless processing protocol.

18. The method of claim 17 wherein the first communication device is a multi-addressable entity on the wired local area network and is addressable by corresponding media access control (MAC) addresses of mobile units associated with the first communication device.

19. The method of claim 18 wherein the second communication device is a multi-addressable entity on the wired local area network and is addressable by corresponding basic service set identifiers (BSS_ID) of access point repeaters (APR) which are supported by the second communication device.

20. The method of claim 19 further including:
the first communication device forwarding, in response to an association request issued by a first mobile unit, the respective association request to the second communication device;
the second communication device processing the respective association request and sending a corresponding association response to the first access point; and
the first access point sending the corresponding association response to the first mobile unit.

21. The method of claim 20 further including:
the second communication device receiving a data frame to be sent to the first mobile unit;
the second communication device sending the data frame enveloped in Ethernet format with the address of the first mobile unit used as a destination address (DA) to the first access point via the wired local area network; and
the first communication device sending the data frame to the first mobile unit.

22. The method of claim of claim 21 further including:
the first communication device receiving a data frame from the first mobile unit to be transmitted to a second mobile unit; and
the first communication device forwarding the data frame to the second communication device for transmission to the second mobile unit.

23. The method of claim 21 further including:
the first communication device receiving a data frame from the first mobile unit to be transmitted to a second mobile unit; and
the first communication device redirecting the data frame to the second mobile unit if one or more criteria are met, the one or more criteria including a first criterion indicating whether the second mobile station is in the same basic service set (BSS) as the first mobile station, a second criterion indicating whether the second mobile station is in a proper power state to receive data frames, and a third criterion indicating whether the first access point is capable of performing one or more data security functions required to process the data frame.

24. A machine-readable medium comprising instructions which, when executed by a machine, cause the machine to perform operations including:
connecting a first communication device in a wireless local area network to a wired local area network;
connecting a second communication device in the wireless local area network to the wired local area network, the first and second communication devices to communicate with each other via the wired local area network;
assigning the first communication device to function as an access point repeater (APR) to transmit information to and receive information from one or more mobile units which are associated with the first communication device, according to a first wireless processing protocol, the first communication device to perform media access functions of the first wireless processing protocol; and
assigning the second communication device to function as an access point server (APS), the second communication device to perform specific point control functions of the first wireless processing protocol.

25. The machine-readable medium of claim 24 further including:
the first communication device forwarding, in response to an association request issued by a first mobile unit, the respective association request to the second communication device;
the second communication device processing the respective association request and sending a corresponding association response to the first access point; and
the first access point sending the corresponding association response to the first mobile unit.

26. The machine-readable medium of claim 25 further including:
the second communication device receiving a data frame to be sent to the first mobile unit;
the second communication device sending the data frame enveloped in Ethernet format with the address of the first mobile unit used as a destination address (DA) to the first access point via the wired local area network; and
the first communication device sending the data frame to the first mobile unit.

27. The machine-readable medium of claim of claim 26 further including:
the first communication device receiving a data frame from the first mobile unit to be transmitted to a second mobile unit; and
the first communication device forwarding the data frame to the second communication device for transmission to the second mobile unit.

28. The machine-readable medium of claim 26 further including:
the first communication device receiving a data frame from the first mobile unit to be transmitted to a second mobile unit; and
the first communication device redirecting the data frame to the second mobile unit if one or more criteria are met, the one or more criteria including a first criterion indicating whether the second mobile station is in the same basic service set (BSS) as the first mobile station, a second criterion indicating whether the second mobile station is in a proper power state to receive data frames, and a third criterion indicating whether the first access point is capable of performing one or more data security functions required to process the data frame.
